(19) United States
(12) Patent Application Publication
(10) Pub. No.: US 2001/0014221 A1
(43) Pub. Date: Aug. 16, 2001

(54) Camera and camera control method

(76) Inventor: Seijiro Tomita, Tokyo (JP)

Correspondence Address: WILLIAM S. FROMMER, Esq., c/o FROMMER LAWRENCE & HAUG LLP, 745 Fifth Avenue, New York, NY, 10151, US

(21) Appl. No.: 09/781,651

(22) Filed: Feb. 12, 2001

(30) Foreign Application Priority Data
Feb. 14, 2000 (JP) P2000-039779

(51) Int. Cl. G03B 35/00

(52) U.S. Cl. 396/325; 396/329; 396/431

(57) ABSTRACT

A camera and camera control method capable of aligning the relative angles of a first photo section and a second photo section with good precision in a short time. The camera comprises a first photo section for capturing an image, and a second photo section installed to have a parallax d versus the first photo section, and forms a three dimensional image from the images captured with the first photo section and the second photo section wherein, said camera contains a laser emission section to beam a laser beam L1 towards nearly the same direction as the optical path CL1 of the first photo section.

### BACKGROUND OF THE INVENTION

1. Field of the Invention

The present invention relates to a camera and camera control method for photographing dynamic three-dimensional images.

2. Description of the Related Art

In recent years, multimedia related enterprises have become an integral part of our daily lives. Cubical images expressing three dimensional spaces in particular, are frequently utilized in games and movies, creating the illusion that the user is actually inside an imaginary space formed within the cubical image, and the user can have the sensation of actually being on-the-spot to experience the contents of the game or movie, etc. As one method to photograph such three dimensional images, two photographic techniques are utilized and the respective images obtained from the photo sections are combined into a composite image.

FIG. 12 is a concept view showing one example of the camera of the related art. A camera 1 is next described while referring to FIG. 12.

The camera 1 of FIG. 12 is comprised of a first photo section 2 and a second photo section 3. The first photo section 2 and the second photo section 3 are respectively installed horizontally and separated by a visual differential or parallax d. The first photo section 2 is installed in a cabinet 1a, and an optical axis CL1 of first photo section 2 is formed in a fixed direction. The second photo section 3 on the other hand, is installed to swing in the direction of the arrow R in cabinet 1a. The optical axis CL2 of second photo section 3 is capable of tilting by an angle θ versus optical axis CL1.

The first photo section 2 has a function to output a first field image fp1 captured by the first photo section 2, to a control section 4. Also, the second photo section 3 has a function to output a second field image fp2 captured by the second photo section 3.

The control section 4 has the function of processing the images captured by the first photo section 2 and second photo section 3 and showing the images on a display section 5. More specifically, the control section 4 for example, alternately displays the first field image fp1 and the second field image fp2 to form one frame image and output the frame image to the display section 5.

The typical operation of the camera 1 is next described while referring to FIG. 12. A target photo surface is first set in place, and the distance L from the camera 1 to the target photo surface S is measured. The angle θ for tilting the second photo section 3 is then calculated by means of the distance L and the visual differential or parallax d between the first photo section 2 and second photo section 3. The optical axis CL1 for the first photo section 2 and the optical axis CL2 for a second photo section 3 form a convergence point CP on the target photo surface S at this time.

The first photo section 2 and second photo section 3 then commences photographing (image capture) and the photographed first field image fp1 and second field image fp2 are respectively sent to the control section 4. The first field image fp1 and second field image fp2 at this time are images of the target photo surface S taken (photographed) from respectively different angles.

The control section 4 forms the first field image fp1 and second field image fp2 into an alternately displayed (interleaved) frame image, and shows that frame image on the display section 5. By displaying the frame image in this way, by using the two field images fp1 and fp2 photographed from two different angles, the user can view a three dimensional image on the display section 5.

In the angle alignment of the second photo section 3 as described above, the distance L from the camera 1 to the target photo surface S to be photographed is measured, and the angle θ for tilting the second photo section 3 is then calculated by utilizing the measured distance L and the preset visual differential or parallax d. The second photo section 3 is then tilted by an amount equivalent to the angle θ and the convergence point CP is then set on the target photo surface S.

However, the distance L to the target photo surface S must be measured in order to calculate the angle θ for tilting the second photo section 3 and a problem occurs because measuring the angle θ requires much time. Another drawback is that measurement of the distance L demands high precision because the angle that the second photo section 3 must be tilted to is extremely small. Yet another problem is that when an error occurs in measurement of the distance L, find adjustments must be made to the second photo section 3 requiring time and effort.

### SUMMARY OF THE PRESENT INVENTION

In order to eliminate the above problems in the related art, this invention has the object of providing a camera and camera control method thereof capable of aligning the relative angles of a first photo section and a second photo section with good precision in a short time.

In order to achieve the above objects, the invention according to claim 1 is a camera comprised of a first photo section for capturing an image, and a second photo section swingable by means of a swing means and installed to have a parallax (visual differential) d set from the first photo section, and a three dimensional image is produced from the images captured with the first photo section and the second photo section wherein, the camera further contains a laser emission section to beam a laser beam in a direction parallel to the optical path of the first photo section.

In the structure according to one aspect of the present invention, the first photo section and second photo section are installed to be separated by a distance equal to a parallax (visual differential) set beforehand, and a three dimensional image is formed from the images captured with the first photo section and the second photo section. A laser emission section is installed in the first photo section or in the second photo section at this time.

The first photo section and second photo section then start photographing (image capture) while a laser beam is output from the laser emission section. A laser reference image from the laser beam is then displayed within a first field image captured (photographed) by the first photo section. A laser reference image is displayed in the same way, by a laser beam, within the second field image captured (photographed) by the second photo section. Then the second photo section is swung so that the laser reference images in the first field image and the second field image are at approximately the same position.

The first photo section and second photo section can in this way be aligned to photograph approximately the same area without having to measure the distance to the target photo surface.

To further achieve the above objects, a control method for a camera aligns the relative positions of the first photo section and the second photo section when generating a three dimensional image utilizing a first field image photographed by the first photo section and a second field image photographed by a second field image wherein, a laser beam is emitted parallel to the optical axis of the first photo section and, the first photo section photographs the first field image containing a reference laser image formed by the laser beam and, the second photo section photographs the second field image containing the reference laser image and the second field image is in an area identical to the first field image and, the second photo section is made to swing in order that the reference laser images positions in the first field image and the second field image will be the same.

In the control method according to another aspect of the present invention, the first photo section and second photo section commence photographing while a laser beam is emitted parallel to the optical axis of the first photo section. A laser reference image is then displayed in the first field image photographed by the first photo section. A laser reference image is also displayed in the same way in the second field image photographed by the second photo section. The second photo section is then made to swing so that the laser reference images are the same position for the first field image and the second field image.

### BRIEF DESCRIPTION OF THE DRAWINGS

FIG. 1 is an overall perspective view of the preferred embodiment of the camera of the invention.

FIG. 2 is a frontal view of the preferred embodiment of the camera of the invention.

FIG. 3 is a bottom view of the preferred embodiment of the camera of the invention.

FIG. 4 is a side view of the preferred embodiment of the camera of the invention.

FIG. 5 is a rear view of the preferred embodiment of the camera of the invention.

FIG. 6 is a concept view of the preferred embodiment of the camera of the invention.

FIG. 7 is a flowchart showing the control method for the preferred embodiment of the camera of the invention.

FIG. 8 is a drawing showing the first field image photographed by the first photo section of FIG. 2.

FIG. 9 is a drawing showing the second field image photographed by the second photo section of FIG. 2.

FIG. 10 is a drawing showing the first field image of another embodiment of the camera control method of the invention.

FIG. 11 is a drawing showing the second field image of another embodiment of the camera control method of the invention.

FIG. 12 is a concept view of one example of the camera of the related art.

### DETAILED DESCRIPTION OF THE PREFERRED EMBODIMENTS

The preferred embodiments of the invention will next be explained in detail while referring to the accompanying drawings.

The following described embodiments are preferred working examples of the invention and so are limited to their preferred technical aspects, however unless otherwise stated, the scope of the invention is not limited by the following description and not limited by these aspects of the invention.

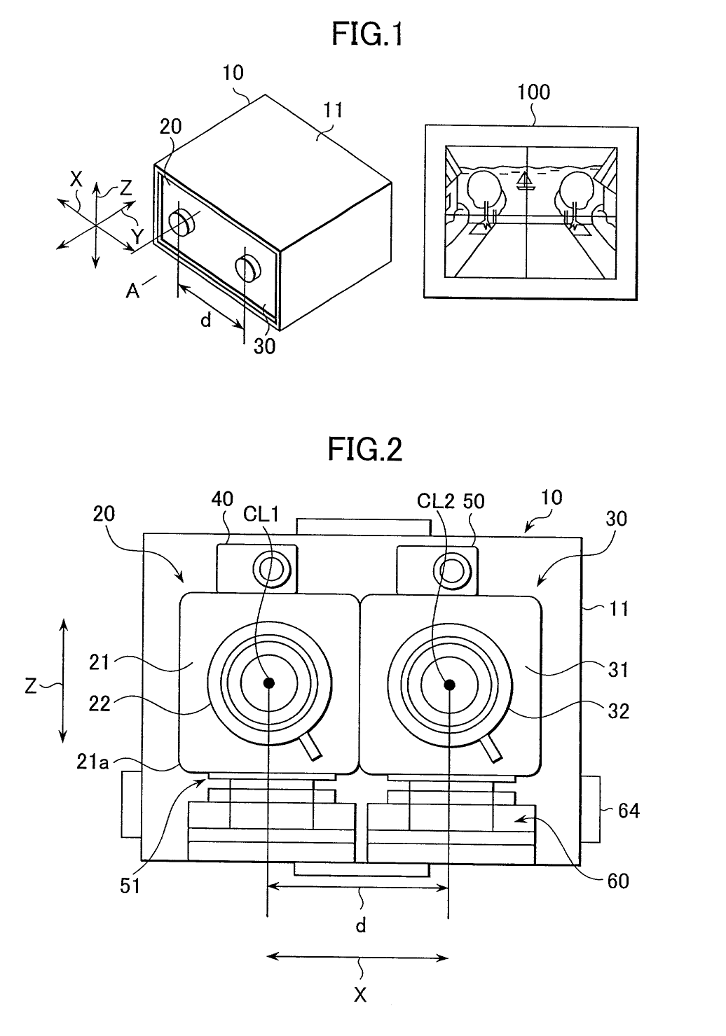

FIG. 1 is an overall perspective view of the preferred embodiment of the camera of the invention. A camera 10 is described while referring to FIG. 1.

The camera 10 of FIG. 1 has a structure containing a first photo section 20 and a second photo section 30 inside a cabinet 11. The images photographed by the first photo section 20 and a second photo section 30 are then sent to the display device 100, and the user can view a three dimensional image on the display device 100.

FIG. 2 is a flat view as seen from the direction of arrow A, of the camera 10 of FIG. 1. The first photo section 20 and the second photo section 30 are described while referring to FIG. 2.

The first photo section 20 and a second photo section 30 of FIG. 2 each have a structure installed with lens mirrors 21, 31.

In the firstphotosection20 and the second photo section 30, the respective optical axes CL1, CL2 for the lens mirrors 21, 31 are installed in arrayed horizontally (direction of arrow X) to have approximately the same height.

The optical axis CL1 of lens mirror 21, and the optical axis CL2 of lens mirror 22 are formed separated by a parallax d in the horizontal direction. This parallax d is for example approximately 65 millimeters, and is set as a narrow distance for the visual impression as seen from both eyes of the viewer. The three dimensional image photographed by the first photo section 20 and the second photo section 30 can in this way be reproduced with a maximum three dimensional effect.

A laser emitter section 40 and 50 are installed respectively above the first photo section 20 and the second photo section 30. The laser emitter sections 40 and 50 are for example, semiconductor lasers and output a laser beam in the visible light region. The laser emitter section 40 emits a laser light L1 roughly parallel to the optical axis CL1 of the first photo section 20. Also, the laser emitter section 50 emits a laser light L2 roughly parallel to the optical axis CL2 of the first photo section 30.

The laser light L1, L2 emitted from the laser emitter section 40, 50 are input as laser reference images RF into the first field image fp1 and the second field image fp2, when photography is performed by the first photo section 20 and the second photo section 30. Here the laser light L1 emitted from the laser emitter section 40 is for example, a laser beam in a line shape and the laser reference image RF is a dot shape. By aligning the relative angles of the first photo section 20 and the second photo section 30 by providing the laser emitter section 40 and utilizing the laser reference image RF, the alignment related later on can be performed in a short time, efficiently and with high precision.

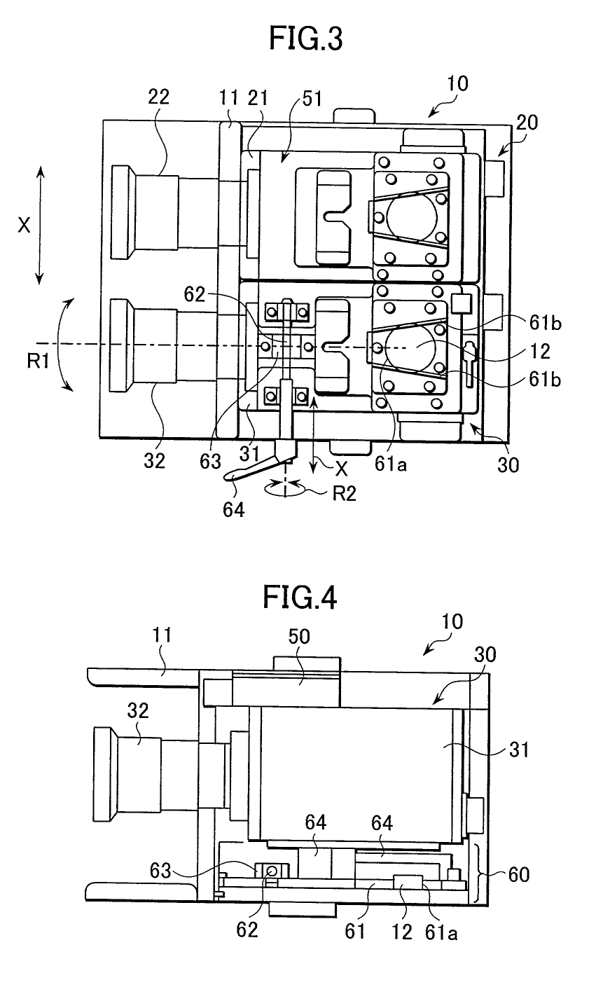

FIG. 3 is a flat view showing the bottom of the camera 10 of FIG. 1. FIG. 4 is a flat view showing the side of the camera 10 of FIG. 1. The installation structure for the first photo section 20 and the second photo section 30 is described while referring to FIG. 2 through FIG. 4.

The first photo section 20 in FIG. 2 is maintained clamped by the clamping member 51 in the cabinet 11. The second photo section 30 is maintained to be swingable by the swing means 60 in the cabinet 11.

The swing means 60 of FIG. 3 is comprised of a moving plate 61, a feed screw 62, a nut 63 and a handle 64. The moving plate 61 is installed on the bottom surface of the cabinet 11 and installed to swingable in the direction of arrow R1 in the cabinet 11. More specifically, a cylinder 12 is formed in the cabinet 11 as shown in FIG. 4, and a hole 61a having approximately the same diameter as the cylinder 12, is formed in the moving plate 61. The cylinder 12 is inserted into the hole 61a so that the moving plate 61 is installed to be swingable around the center of the cylinder 12 in the cabinet 11.

A tapered section 61b is formed in the tangential direction of the hole 61a in the moving plate 61 of FIG. 3 to gradually narrow towards the lens mirror 32 side. This tapered section 61b has the function of preventing an offset or deviation in the optical axis CL2 of the second photo section 30, when the moving plate 61 swings centering on the cylinder 12.

A nut 63 is fastened to the moving plate 61, and the feed screw 62 is inserted into the nut 63. When the feed screw 62 rotates in the direction of the arrow R2, the moving plate 61 moves in the direction of the arrow Y. A handle 64 for example is installed on the feed screw 62, and contrived so that the rotation of the handle 64 in the direction of the arrow R2 makes the feed screw 62 rotate.

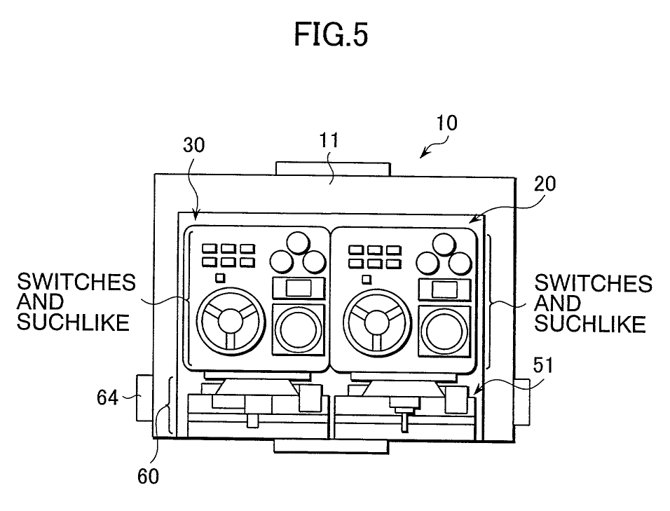

FIG. 5 is a view of the camera 10 of FIG. 1 as seen from the rear. Objects such as switches are installed on the first photo section 20 and second photo section 30 to adjust the operation of the first photo section 20 and second photo section 30. More specifically, the user can operate these switches to align the focus, exposure and contrast of the first field image fp1 photographed and the second field image fp2 photographed respectively by the first photo section 20 and second photo section 30.

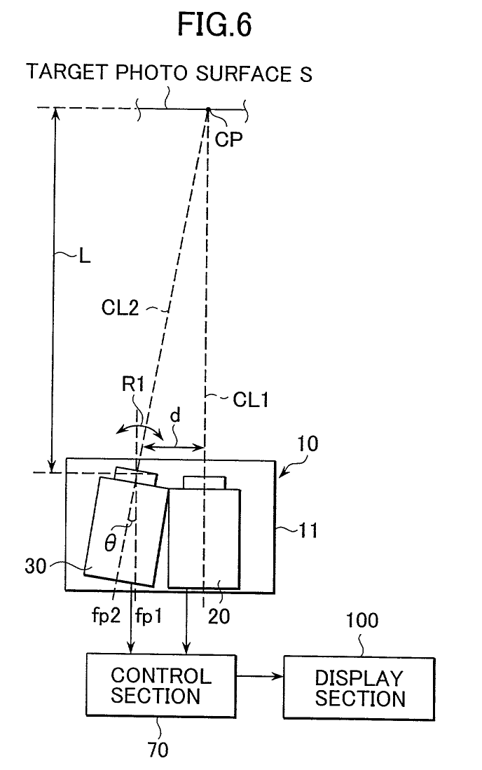

FIG. 6 is a concept view showing the preferred embodiment of the camera 10 of the invention. The operation of the camera 10 is explained next while referring to FIG. 6.

The camera 10 is first moved to establish the position of the optical axis CL1 of the first photo section 20 in approximately the center of the area to be photographed on the target photo surface S in FIG. 6. The angle of the second photo section 30 is then aligned in order to set the convergence point CP on the target photo surface S. More specifically, the handle 64 is operated to rotate the feed screw 62 in the direction of the arrow R2, and the nut 63 moves in the direction of the arrow X by means of the feed screw 62 as shown in FIG. 3. The moving plate 61 then swings in the direction of the arrow R1 centering on the cylinder 12. The tapered section 61 prevents the optical path CL2 of the second photo section 30 from becoming offset (deviated) at this time.

The photographing then starts when the second photo section 30 is set so that the convergence point CP is aligned onto the target photo surface S.

Here, the tilting of the optical path CL2 angle of the second photo section 30 for setting the convergence point CP is performed by a method as follows.

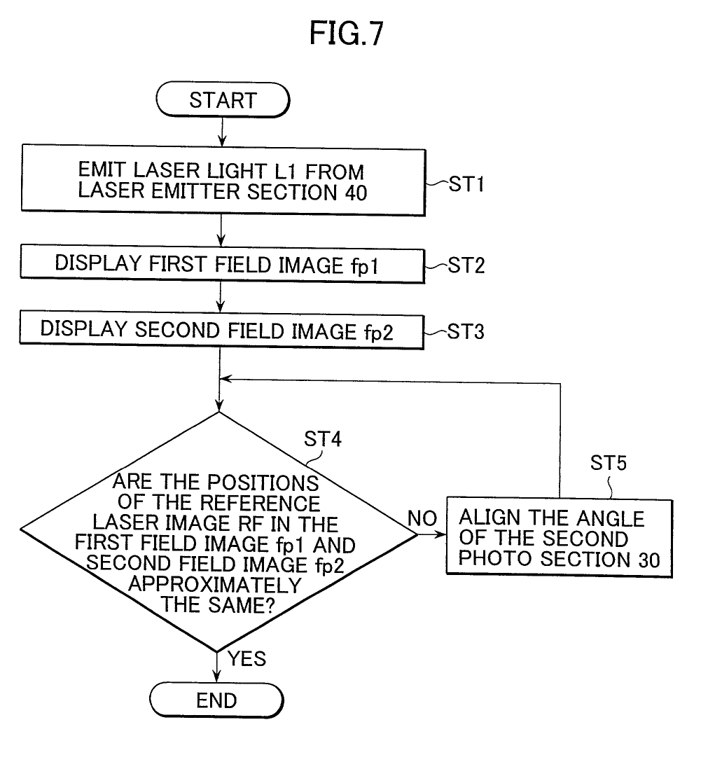

FIG. 7 is a flowchart showing a control method for the preferred embodiment of the camera of the invention. The photographic method is next explained while referring to FIG. 1 through FIG. 7. The example in FIG. 7 refers to the case when only the laser emitter section 40 installed on the first photo section 20 of FIG. 2 is operated.

First of all, in step ST1, a laser light L1 is emitted from the laser emitter section 40 of FIG. 2. The laser light L1 at this time, is formed as a light ray approximately in parallel with the optical axis CL1 of the first photo section 20.

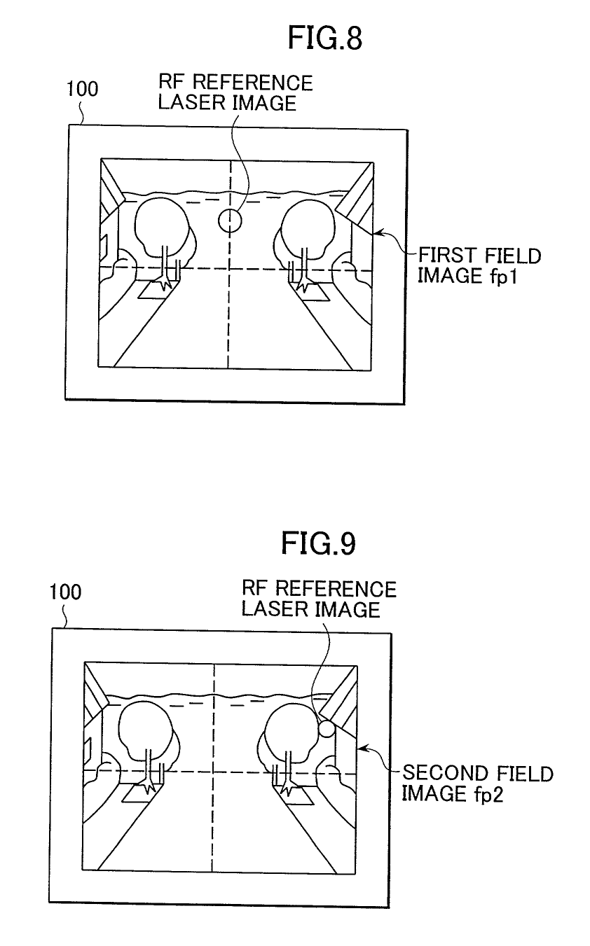

Next, in step ST2, the first field image fp1 photographed by the first photo section 20 is shown on the display section 100. A reference laser image RF is then formed by the laser light L1 in the section above the screen center in the field image fp1 as shown for example in FIG. 8. Here, the laser reference image RF is shown as a dot shape since the laser light L1 is emitted in a line (or beam) approximately parallel to the optical axis CL1.

In step ST3, the second photo section 30 commences photographing, and the second field image fp2 photographed by the second photo section 30 is shown on the display section 100.

Then, in step ST4, a check is made to determine if the reference laser image RF is formed in approximately the same section in the first field image fp1 and the second field image fp2. In other words, the reference laser image RF is formed in approximately the same position in the first field image fp1 and second field image fp2 when the identical area is photographed on the target photo surface S by the first photo section 20 and second photo section 30. The convergence point CP can therefore be set on the target photo surface S by comparing the first field image fp1 and second field image fp2.

More specifically, as shown in FIG. 9, the reference laser image RF is projected by the laser light L1 on the right edge of the second field image fp2. Therefore, in the case that the position of the reference laser image RF is deviated (offset) in the first field image fp1 and second field image fp2, the angle of the second photo section 30 is aligned in step ST5. The second photo section 30 here, swings in the direction of the arrow R1 by the rotation of the handle 64 of FIG. 3. The horizontal swing of the second photo section 30, makes the optical axis CL2 of second photo section 30, or in other words, the area capable of being photographed by second photo section 30, shift in the horizontal direction.

The handle 64 is then operated while observing the display section 100, and the tasks in steps ST4, ST5 repeated until the reference laser images RF are in the same position. The handle 64 in particular, is operated while alternately displaying the first field image fp1 and second field image fp2 on the display section 100. The person performing the alignment can in this way align the angle of the second photo section 30 by rotating the handle 64 while observing the display section 100. The improved user interface therefore allows the convergence point CP to be efficiently aligned in a short time. Further, there is no need to measure the distance L to the target photo surface S, so that errors in making measurements are prevented, and the second photo section 30 positioning can be performed with high precision.

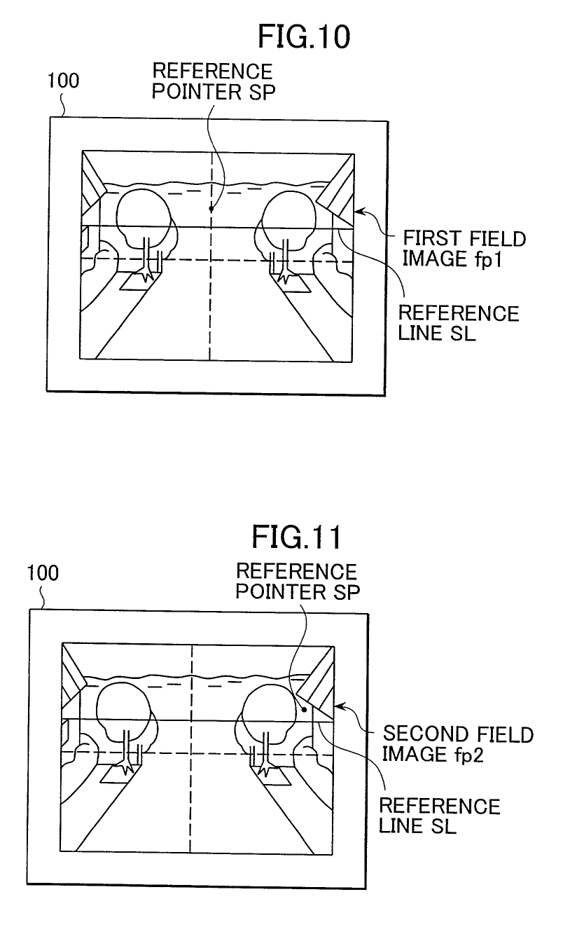

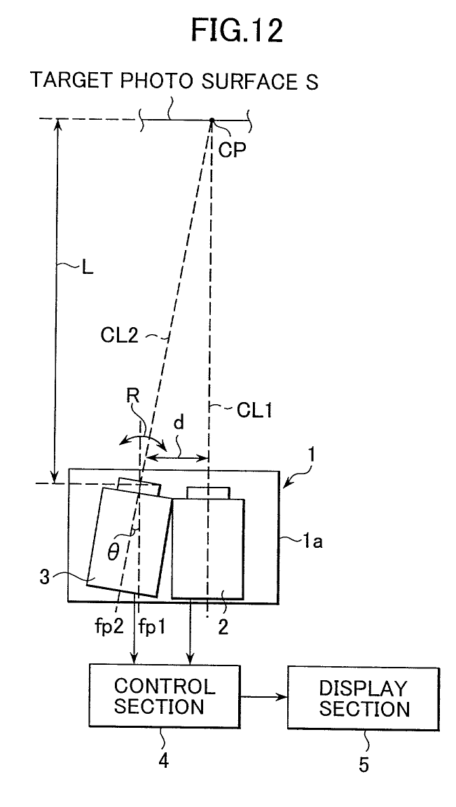

FIG. 10 and FIG. 11 are drawings showing another embodiment of the camera control method of this invention. This camera control method is described while referring to FIG. 10 and FIG. 11. The camera utilized to explain the camera control method in FIG. 10 and FIG. 11 is the same as the camera shown in FIG. 1 through FIG. 6 so an explanation is omitted.

The reference laser image RF is comprised from the reference pointer SP and the reference line SL in the first field image fp1 and second field image fp2 of FIG. 10 and FIG. 11. The reference pointer SP is derived from the laser light L emitted from the laser emitter section 40 of FIG. 2. The reference line SL is derived from the laser light L2 emitted from the laser emitter section 50 installed on the second photo section 30.

More specifically, the laser emitter section 50 is output while the laser light L2 is made to horizontally scan (direction of arrow X) a fixed area (for example, the horizontal area of the screen image). The reference pointer SP from the laser light L and the reference line SL from the laser light L2 are therefore contained in the first field image fp1 of FIG. 10. The reference laser image RF and the reference line SL are in the same way contained in the second field image fp2 of FIG. 11. The height of the first photo section 20 or the second photo section 30 is then aligned so that the heights of the reference pointer SP and the reference line SL (direction of Z arrow) match each other.

Therefore, even if the heights of the first photo section 20 and second photo section 30 are different from each other, alignment can be performed while observing the first field image fp1 and second field image fp2 shown on the display section 100. Alignment of the relative positions of the first photo section 20 and second photo section 30 can therefore be performed in a short time and with good efficiency.

In the above embodiment, the convergence point CP is aligned by utilizing the laser light L1 emitted from the laser emitter section 40 so that the convergence point CP can be checked on the display section 100 without having to measure the actual distance. The setting of the convergence point CP required when setting the three-dimensional image can therefore be with good efficiency and in a short time.

The embodiment of the invention is not limited by the above working examples.

The laser emitter section 40 in FIG. 2 for example is installed above the first photo section 20, however the laser light 1 may be emitted in parallel with the optical axis CL1 of the first photo section 20, and further, the laser light L1 may be emitted within a photographing (image capture) range of the first photo section 20. If the angles of the second photo section 30 are then aligned so that the reference laser images RF of the first field image fp1 and second field image fp2 overlap, a convergence point CP can then be formed on the target photo surface.

In FIG. 3, the second photo section 30 swings in the direction of the arrow R1 by operating the handle 64 to turn the feed screw; however, the swing of the second photo section 30 may also be controlled by a drive means such as a motor.

Further, after aligning the relative positions (direction of arrow Z) of the first photo section 20 and the second photo section 30 by means of the camera control method shown in FIG. 10 and FIG. 11, the angle of the second photo section 30 maybe aligned by means of the camera control method shown in FIG. 7.

The invention as described above, is capable of providing a camera and camera control method capable of aligning the relative angles of a first photo section and a second photo section with good precision in a short time.

What is claimed is:

1. A camera comprising a first photo section for capturing an image, and a second photo section swingable by means of a swing means, being installed to have a visual differential d set from said first photo section, and producing a three dimensional image from the images captured with said first photo section and said second photo section, wherein said camera further contains a laser emission section to emit a laser beam in a direction parallel to the optical path of said first photo section forming a reference when aligning the angle of said second photo section.

2. A camera according to claim 1, wherein said laser emission section is installed above said first photo section.

3. A camera control method for aligning the relative positions of said first photo section and said second photo section when generating a three dimensional image utilizing a first field image photographed by said first photo section and a second field image photographed by a second field image, wherein a laser beam is emitted parallel to the optical axis of said first photo section and, said first photo section photographs said first field image containing a reference laser image formed by said laser beam and, said second photo section photographs said second field image containing said reference laser image and said second field image is in an area identical to said first field image and, said second photo section is made to swing to make the reference laser images positions in said first field image and said second field images the same.

4. A camera control method according to claim 3, wherein said first field image and said second field image are alternately displayed when making the reference laser images portions in said first field image and said second field images the same.
